(19) United States
(12) Patent Application Publication
(10) Pub. No.: US 2009/0238919 A1
(43) Pub. Date: Sep. 24, 2009

(54) METHOD OF MANUFACTURING VINEGAR WITH HIGH EXTRACT CONTENT

(76) Inventors: Fumie Muroki, Aichi (JP); Hironobu Asai, Aichi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/909,842

(22) PCT Filed: Apr. 13, 2006
(86) PCT No.: PCT/JP2006/307839

§ 371 Date: Sep. 27, 2007

(30) Foreign Application Priority Data
Apr. 27, 2005 (JP) 2005-128881

(51) Int. Cl. C12J 1/04; A23L 1/23

(52) U.S. Cl. 426/17; 426/534

(57) ABSTRACT

The object of the present invention is to provide a method of manufacturing vinegar with high extract content that keeps the original flavor of raw materials and has favorable flavor for vinegar under the circumstance of high extract content.

The present invention provides a method of manufacturing vinegar by submerged fermentation, characterized by including: performing acetate fermentation using a fermentation solution which has an extract content of 0.1 w/v % or more and less than 6.0 w/v % and continues the acetate fermentation at a generation rate of acetic acid of 0.5 g/L·hr or more; raising the extract content to reach 6.0 w/v % or more and 55.0 w/v % or less at the time of completion of fermentation; and suppressing an induction period so that the induction period does not appear or is 10 hours or less, whereby obtaining vinegar with extract content of 6.0 w/v % or more and 55.0 w/v % or less.

### TECHNICAL FIELD

The present invention relates to a method of manufacturing vinegar with high extract content, and more specifically, to a method according to which vinegar having a good flavor is manufactured effectively in a short period of time by suppressing an appearance of an induction period caused by inhibition of acetate fermentation due to the extract content.

### BACKGROUND ART

In general, methods of manufacturing vinegar are broadly classified into: surface fermentation that performs fermentation by proliferating an acetic acid bacterium at a surface of a fermentation solution; and fermentation using a submerged culture to perform the fermentation by supplying air (oxygen) to an entire of a fermentation solution after reducing sizes of bubbles by stirring or the like, while aerating air (oxygen). However, in view of fermentation efficiency, the fermentation method using a submerged culture is considered to be more excellent than the surface fermentation method.

Ingredients of vinegar include acetic acid, other organic acids (such as gluconic acid, lactic acid, and citric acid), sugar, nitrogen, and the like, and in particular, acetic acid is considered to have functions of refreshing, lowering blood pressure, and calcium supplementation. Further, the ingredients of vinegar include a salt-free soluble solid (hereinafter, referred to as “extract”), and the solid content in vinegar used in the household is generally about 0.1 w/v % to 13.8 w/v %. The extract mainly includes sugar, thereby tasting sweet and being suited for drink. Therefore, the vinegar with high extract content is often used by choice.

By the way, it is desirable that manufactured vinegar has a good flavor for enhancement of the commercial value, and the vinegar manufactured by submerged fermentation is also desired to have good flavor.

However, in the case that vinegar with high extract content is manufactured by submerged fermentation, if the acetate fermentation is performed using an acetic acid bacterium having an ability to ferment actively under circumstances of the submerged fermentation, various organic acids other than acetic acid are generated due to occurrence of reactions other than oxidation from ethanol to acetic acid. As a result, undesirable flavor for vinegar is generated, resulting in a problem of the vinegar being unsatisfactory in quality.

That is, in the case of manufacturing vinegar with an extract content of less than 3.0 w/v %, an amount of raw materials used is small, so affects on the flavor are less, resulting in no serious problem. However, in the case of manufacturing vinegar with high extract content, i.e., vinegar with an extract content of 3.0 w/v % or more, the affect on the flavor becomes out of permissible level. Further, in the case of manufacturing vinegar with high extract content, i.e., vinegar with an extract content of 6.0 w/v % or more by submerged fermentation, the affect on the flavor becomes much larger.

Accordingly, there has been required development of a method of manufacturing vinegar that keeps the original flavor of raw materials and has good flavor with less generation of organic acids other than acetic acid in manufacturing vinegar under the circumstance of high extract content, in particular, even in manufacturing vinegar with high extract content, i.e., vinegar with an extract content of 6.0 w/v % or more.

Patent Document 1 introduces a method of manufacturing vinegar having a good flavor even under the condition of high extract content by adjusting the composition of mash (broth, brewed vinegar) so that the amino-acid level in the mash is about 2.0 or less and the ratio of nonfermentable sugars to fermentable sugars in the extract of the mash is about 0.6 or less in manufacturing vinegar by submerged fermentation.

However, according to such method, foaming in manufacturing can be suppressed, but the resultant vinegar does not fully keep the original flavor of raw materials. Further, it is necessary to limit the amino-acid level and ratio of nonfermentable sugars in the mash used, so the manufacturing condition or the quality of a product may be limited.

Under such circumstances, there has been expected the development of a method according to which vinegar having a good flavor is manufactured under the circumstance of high extract content without limiting the amino-acid level and the ratio of nonfermentable sugars.

### Patent Document 1: JP Hei 4-59874 B

### DISCLOSURE OF THE INVENTION

### Problems to be Solved by the Invention

An object of the present invention is to provide a method of manufacturing vinegar with high extract content that keeps the original flavor of raw materials and has favorable flavor for vinegar under the circumstance of high extract content.

Further, another object of the present invention is to provide a method according to which the above-mentioned vinegar with high extract content is manufactured effectively in a short period of time by raising the extract content in a fermentation solution without appearance of induction period caused by fermentation inhibition due to the extract or at a rate to adjust the period to 10 hours or less.

### Means for Solving the Problems

The inventors of the present invention have made extensive studies to solve the above-described problems, and as the result of which, they have found out that, in the case that an extract is added at once to a fermentation solution at a concentration equal to or higher than a certain concentration in manufacturing vinegar with high extract content by submerged fermentation, activity of an acetic acid bacterium is lowered, resulting in occurrence of fermentation inhibition. In addition, they have also found out that, if the induction period caused by the lowering of the activity lasts 10 hours or more, the flavor of the resultant vinegar is undesirable.

This is probably because the acetic acid bacterium is transformed into one suitable for the circumstance of high extract content in the induction period under the circumstance of high extract content. In addition, they have found out that, in fermentative production of vinegar under the circumstance of high extract content, vinegar that keeps the original flavor of raw materials and has good flavor and refreshing taste can be manufactured if the fermentation time is as short as possible under the circumstance of high extract content, preferably if the fermentation is completed within 72 hours.

This is probably because the fermentation can be completed without providing the time for transformation into an acetic acid bacterium suitable for the circumstance of high extract content if the fermentation time is as short as possible in acetate fermentation under the circumstance of high extract content. Here, the term “acetic acid bacterium suitable for the circumstance of high extract content” used herein refers to a bacterium that generates flavor undesirable for vinegar by the occurrence of reactions other than oxidation to convert ethanol to acetic acid.

That is, in a manufacturing method, by which the extract content in a fermentation solution in a fermentor is drastically raised, the induction period appears due to the fermentation inhibition, and the period of time for fermentation is extended because of the reduced activity, resulting in transformation into an acetic acid bacterium suitable for the circumstance of high extract content. Therefore, it has been clarified that substances other than acetic acid are generated, and vinegar with good flavor and high extract content cannot be manufactured.

Based on such the findings, the inventors of the present invention have clarified that vinegar with high extract content can be manufactured in a shorter period of time with a higher degree of efficiency than the case of the conventional method if fermentation is initiated at an extract concentration equal to or lower than a certain concentration at which substances other than acetic acid are not generated, followed by adding an extract-containing solution at a rate equal to or lower than a certain rate at which the induction period caused by fermentation inhibition due to the extract is not generated.

As a result, they have found out that it is possible to manufacture vinegar with high extract content having good flavor and refreshing taste, which could have never been obtained, to thereby complete the present invention.

To be specific, a first invention relates to a method of manufacturing vinegar by submerged fermentation, characterized by including: performing acetate fermentation using a fermentation solution which has an extract content of 0.1 w/v % or more and less than 6.0 w/v % and continues the acetate fermentation at a generation rate of acetic acid of 0.5 g/L·hr or more; raising the extract content to reach 6.0 w/v % or more and 55.0 w/v % or less at the time of completion of fermentation; and suppressing an induction period so that the induction period does not appear or is 10 hours or less, whereby obtaining vinegar with an extract content of 6.0 w/v % or more and 55.0 w/v % or less.

A second invention relates to a method of manufacturing vinegar according to Claim 1, characterized in that a rate of the raising of the extract content in the fermentation solution is 0.1 w/v % or more and 10.0 w/v % or less per hour in the acetate fermentation step.

A third invention relates to a method of manufacturing vinegar according to Claim 1 or 2, characterized in that a fermentation time in a fermentation solution with the extract content of 6.0 w/v % or more and 55.0 w/v % or less is adjusted to 72 hours or less in an acetate fermentation step.

A fourth invention relates to vinegar, which is manufactured by the method of manufacturing vinegar according to Claim 1, 2, or 3.

### EFFECT OF THE INVENTION

According to the present invention, there may be manufactured vinegar that keeps the original flavor of raw materials and has favorable flavor for vinegar under the circumstance of high extract content without limiting the amino-acid level or the ratio of nonfermentable sugar in mash.

Moreover, according to the present invention, acetate fermentation may be performed in a short period of time with a high efficiency to manufacture vinegar with high extract content, and vinegar with good flavor and high extract content may be manufactured.

### BEST MODE FOR CARRYING OUT THE INVENTION

Hereinafter, the present invention will be described in detail.

A method of manufacturing vinegar of the present invention relates to fermentative production of vinegar with good flavor and extract content of 6.0 w/v % or more and 55.0 w/v % or less.

The term “extract” means a salt-free soluble solid, which is a vinegar ingredient derived from a raw material to be added to a culture solution for fermentative production.

In the case that the extract content in vinegar is less than 6.0 w/v %, vinegar with good flavor may be manufactured without using the method of the present invention. The present invention provides a method according to which vinegar with high extract content, i.e., vinegar with the extract content of 6.0 w/v % or more and 55.0 w/v % or less is manufactured effectively in a short period of time.

Examples of vinegar with such the extract content include brewed vinegars such as grain vinegar, rice vinegar, black vinegar made from rice, apple vinegar, and grape vinegar.

The acetic acid bacterium to be used in the present invention is not particularly limited as long as it is a general acetic acid bacterium to be used for fermentative production of vinegar. For example, an acetic acid bacterium belonging to the genus Acetobacter is used, and Acetobacter aceti IFO 3281 strain, Acetobacter aceti IFO 3283 strain, and the like are effectively used.

Such the acetic acid bacterium is inoculated to a fermentation tank for submerged fermentation, to which a raw material solution containing an alcohol, a nutrient source for the acetic acid bacterium, and the like are charged to initiate cultivation for preparation of an inoculum solution. That is, it is desirable that an acetic acid bacterium is inoculated, and then an alcohol or an aqueous alcohol solution is added to perform acetate fermentation, to thereby raise the acetic acid content. In general, an alcohol or an aqueous alcohol solution is added so that the sum of the acetic acid content and alcohol content is about 6 to 10%, and at the time when the acetic acid content and alcohol content reach 5 to 9 w/v % and about to 3.0 v/v %, respectively, the resultant fermentation solution may be used as an inoculum solution.

Further, a raw material to raise the extract content may be added to an inoculum solution. For example, a microbial extract such as peptone or yeast extract, or sugar such as fructose or saccharose may be added, while a saccharified solution of grain including rice, wheat, or corn, sake lees extract, and a raw material solution containing sugars such as fruit juice or the like may be arbitrarily diluted before use. Note that, various organic acids other than acetic acid may be generated in fermentation in the case that the extract content in the fermentation solution exceeds 6.0 w/v % in a composition of the inoculum solution at the time of the beginning of the fermentation, so that it is preferable that such raw material solution containing sugars and so on are arbitrarily diluted before use to adjust the extract content to 6.0 w/v % or less, preferably 3.0 to 5.0 w/v %.

The extract content in the inoculum solution should be adjusted to 0.1 w/v % or more and less than 6.0 w/v %, preferably 3.0 to 5.0 w/v %.

As described above, fermentation may be performed to manufacture vinegar with high extract content, but in the present invention, an alcohol may be added to a raw material to raise the extract content, which is added for acetate fermentation. In the case of adding an alcohol, the alcohol content may be adjusted depending on the intended acetic acid content in vinegar.

On the other hand, in the case that no alcohol is added to a raw material to raise the extract content, it is preferable that an alcohol required for acetate fermentation is previously added into a fermentation tank or that an alcohol or an aqueous alcohol solution is added separately from a raw material to raise the extract content. In both cases of adding a raw material solution to raise the extract content or adding a raw material solution to raise the extract content that contains an alcohol, the alcohol content in a fermentation solution is preferably 5 v/v % or less.

The acetate fermentation to produce vinegar with high extract content is performed using a fermentation tank for submerged culture at 25 to 38° C., preferably 30.0 to 32.0° C.

The aeration method in a fermentation tank for submerged culture is not particularly limited, and a well-known method may be employed. An example thereof includes a method of supplying gas containing oxygen such as air or oxygen gas through a vent pipe. The aeration volume may be arbitrarily set depending on a fermentation situation. For example, it may be controlled by supplying air to the lower part of a fermentation solution at the aeration volume of 0.02 to 1 vvm (volume of aeration/volume of fermentation solution/minute) and then by fining and dispersing air using a stirring machine to keep the dissolved oxygen level of about 0.2 to 8 ppm in the fermentation solution.

The fermentation tank to be used in the present invention is not particularly limited and may be one that has been conventionally used for fermentation of vinegar by submerged culture, and for example, a submerged fermentation apparatus that employs a general aeration and stirring system may be used. In addition, as for the fermentation method that may be employed include various conventional methods such as batch fermentation, semicontinuous fermentation, and two-stage fermentation.

When the extract content in a fermentation solution is raised at once, the activity of an acetic acid bacterium may be lowered because of fermentation inhibition caused by high extract content, resulting in the occurrence of the induction period. The term “induction period” to be used in the present invention is defined as a period when acetic acid is not generated at all.

To obtain vinegar with good flavor and high extract content, it is preferable to prevent the occurrence of the induction period or to adjust the period to 10 hours or less, and if the period exceeds 10 hours, the flavor of the resultant vinegar deteriorates. Further, in order to adjust the induction period to 10 hours or less, for example, the raising of the extract content in a fermentation solution may be controlled to 0.1 w/v % or more and 10.0 w/v % or less per hour.

However, even if the raising rate of the extract content is controlled to a lower level in order to adjust the induction time to 10 hours or less, the fermentation time is extended in the case that the level is too low, and if the fermentation time exceeds 72 hours in a fermentation solution with the extract content of 6.0 w/v % or more, the flavor of the resultant vinegar rather deteriorates. Therefore, it is preferable to control the addition rate of a raw material solution so that the fermentation, in which the extract content in a fermentation solution is raised at 0.1 w/v % or more and 10.0 w/v % or less per hour and the extract content in a fermentation solution is 6.0 w/v % or more and 55.0 w/v % or less, is completed within 72 hours, preferably 48 hours.

The raising rate of the extract content corresponds to the slope in a graph with time on the lateral axis and the extract content on the vertical axis. Therefore, raising of the extract content at a predetermined rate means addition of a raw material to raise the extract content in line with the slope in the case of the above-mentioned extract content raising rate of 0.1 w/v % or more and 10.0 w/v % or less per hour. Note that, if a raw material is added under such conditions, the extract content may be raised rather stepwise.

In this case, for example, in the case that the extract content is raised from 5 w/v % to 10 w/v % at the extract raising rate of “5 w/v %/hour”, a raw material to raise the extract content is added over 1 hour to raise the extract content by 5 w/v %. Further, in the case that the extract content is raised from 5 w/v % to 7.5 w/v % at the extract raising rate of “5 w/v %/hour”, a raw material to raise the extract content is added over 0.5 hours to raise the extract content by 2.5 w/v %.

As a composition of raw material solution to raise the extract content, there may be arbitrarily used a solution having the same composition as the solution described above as a solution that may be previously added to an inoculum solution. A raw material solution to raise the extract content added in advance to an inoculum solution and a raw material to be added in a fermentation step may be the same or different from each other. Note that, the raising rate of the extract content is not required to be constant and may be arbitrarily varied depending on the fermentation time, the extract content suitable for vinegar, and the like.

The fermentation is completed at the time when fermentation proceeds until a predetermined acetic acid content is attained by the above-described method, and then the fermentation solution of vinegar with high extract content is taken out from the fermentation tank and subjected to the steps of removal of acetic acid bacteria, aging, clarification treatment, and sterilization by general methods, to thereby obtain vinegar with high extract content as a product.

When vinegar with high extract content is manufactured by such the manufacturing method, the appearance of the induction period, which is generated by lowering the activity of acetic acid bacteria caused by fermentation inhibition due to the extract, is avoided and vinegar with high extract content is manufactured effectively in a short period of time, and the resultant vinegar with high extract content keeps the original flavor of raw materials and has good flavor.

### EXAMPLES

Hereinafter, the present invention will be specifically described with reference to examples, but the present invention is not limited to these examples.

### Example 1

### (1) Preparation of Inoculum Solution

An acetic acid bacterium to be added into a fermentation tank was precultured.

Acetobacter aceti IFO 3281 strain was cultivated with shaking under the conditions of 30° C. and 200 rpm for 48 hours in sterilized 804 medium (10 g of polypeptone, 10 g of yeast extract, 10 g/liter of glucose) supplemented with an alcohol (ethanol) so as to achieve 3 v/v %, to thereby obtain a preculture solution.

1,000 ml of the resultant preculture solution was added into a fermentation tank for submerged culture (10 L volume: manufactured by Mitsuwa Scientific Corp.) having 2,000 ml of a raw material solution including nutritional sources for the acetic acid bacterium, 3 v/v % alcohol, and 0.5 w/v % acetic acid, and submerged fermentation was performed under the conditions of 30° C., 500 rpm, and 0.2 vvm to initiate fermentation for preparation of an inoculum solution.

Fermentation was continued while feeding an addition solution having a composition of the extract content of 3.0 w/v % and the sum of acetic acid content and alcohol content of 8.0% from the beginning of fermentation.

At the time when fermentation proceeded until the final extract content, acetic acid content, and alcohol content reached 3.0 w/v %, 6.0 w/v %, and about 1.5 v/v %, respectively, the resultant fermentation solution was provided to the following test as an inoculum solution.

### (2) Changes in Induction Period and Flavor Caused by Difference in Raising Rate of Extract Content

To 3.0 L of the inoculum solution prepared in (1) above was added 7.0 L of a diluted solution of a saccharified-rice solution with alcohol content of 3.0 v/v %, acetic acid content of 5.0 w/v %, and extract content of 27.3 w/v % so as to reach the final extract content, i.e., extract content in vinegar of 20.0 w/v %, whereby performing the fermentation.

In this case, experiment was carried out in five experimental groups at the raising rate of the extract content in the fermentation solution of 15.0 w/v %, 10.0 w/v %, 7.0 w/v %, 5.0 w/v %, or 3.0 w/v % per hour.

That is, in the case that the raising rate of the extract content was 15.0 w/v % per hour, 7 L of the solution was added over 1 hour and 49 minutes. In the case that the raising rate of the extract content was 10.0 w/v % per hour, the solution was added over 2 hours and 44 minutes. In the case that the raising rate of the extract content was 7.0 w/v % per hour, 7 L of the solution was added over 3 hours and 54 minutes. In the case that the raising rate of the extract content was 5.0 w/v % per hour, 7 L of the solution was added over 5 hours and 28 minutes. In the case that the raising rate of the extract content was 3.0 w/v % per hour, the solution was added over 9 hours and 6 minutes. The temperature was adjusted to 30.0° C., and fermentation was performed until the acidity and residual alcohol reached 7.0% and 0.3%, respectively.

In the cases that the raising rates of the extract content in the fermentation solution were 15.0 w/v %, 10.0 w/v %, and 7.0 w/v % per hour, the induction period appeared after the beginning of fermentation. Further, it was found that, in the case that the raising rate of the extract content was higher, the induction period became longer, and the activity of the acetic acid bacterium became lower, so the time from the beginning to the completion of the fermentation became longer. In addition, in the case that the fermentation time was long, the degree of dispersal of the alcohol due to continuous aeration was large. In this case, the flavors of the vinegars obtained in the respective experimental groups were evaluated, and as a result, it was found that the vinegar obtained in the experimental group of the raising rate of the extract content of 15.0 w/v % per hour clearly had undesirable flavor for a vinegar unlike in the case of the other experimental groups.

Note that the vinegar flavors were evaluated by organoleptic tests using the vinegar obtained in the case of the raising rate of the extract content of 3.0 w/v % per hour as a control, which were performed by 20 organoleptic test examiners. The evaluation was performed on the five grade criteria of 1: bad, 2: slightly bad, 3: comparable, 4: slightly good, and 5: good, and the mean value of the results of the respective examiners was defined as an evaluation value.

Table 1 shows the relationship between the induction periods and flavors in the cases of different raising rates of the extract contents.

TABLE 1

| Raising rate of extract | Induction period | Fermentation | Flavor |
|---|---|---|---|
| content (w/v %/hour) | (hour) | time (hour) | evaluation |
| 15 | 13 | 35 | 1.6 |
| 10 | 10 | 31 | 2.8 |
| 7 | 5 | 25 | 3.0 |
| 5 | None | 20 | 3.1 |
| 3 | None | 20 | — |

As is clear from Table 1, in the cases that the raising rates of the extract content were 10 w/v % or less per hour, the induction periods after the beginning of fermentation were 10 hours or less, and the vinegar flavors have no significant differences. However, in the case that the raising rate of the extract content was over 10 w/v % per hour, the induction period appeared over 10 hours or more, resulting in significant reduction in the evaluation of the vinegar flavor.

The results revealed that the induction period should be adjusted to 10 hours or less to manufacture vinegar with good flavor under the circumstance of high extract content. Further, it was found that, to adjust the induction period to 10 hours or less, a raw material solution to raise the extract content should be added while controlling the raising rate of the extract content per hour to 10.0 w/v % or less.

### Example 2

### (1) Preparation of Inoculum Solution

An acetic acid bacterium to be added into a fermentation tank was precultured.

Acetobacter aceti IFO 3281 strain was cultivated with shaking under the conditions of 30° C. and 200 rpm for 48 hours in sterilized 804 medium (10 g of polypeptone, 10 g of yeast extract, 10 g/liter of glucose) supplemented with an alcohol (ethanol) so as to achieve 3 v/v %, to thereby obtain a preculture solution.

1,000 ml of the resultant preculture solution was added into a fermentation tank for submerged culture (10 L volume: manufactured by Mitsuwa Scientific Corp.) having 2,000 ml of a raw material solution including nutritional sources for the acetic acid bacterium, 3 v/v % alcohol, and 0.5 w/v % acetic acid, and submerged fermentation was performed under the conditions of 30° C., 500 rpm, and 0.2 vvm to initiate fermentation for preparation of an inoculum solution.

Fermentation was continued while feeding an addition solution having a composition of the extract content of 6.0 w/v % and the sum of acetic acid content and alcohol content of 8.0% from the beginning of fermentation.

At the time when fermentation proceeded until the final extract content, acetic acid content, and alcohol content reached 6.0 w/v %, 6.5 w/v %, and about 1.0 v/v %, respectively, the resultant fermentation solution was provided to the following test as an inoculum solution.

### (2) Changes in Flavor Caused by Fermentation Time

To 3.0 L of the inoculum solution was added 7.0 L of a diluted solution of a saccharified-rice solution with alcohol content of 5.0 v/v %, acetic acid content of 3.0 w/v %, and extract content of 40.0 w/v % so as to reach the final extract content of 30.0 w/v %, and the fermentation was performed. 7 L of the saccharified-rice solution was added over 13 hours and 20 minutes at the raising rate of the extract content of 3.0 w/v % per hour.

In this case, the induction period did not appear, and the fermentation time required for achieving the final extract content of 6.0 w/v %, the acidity of 7.0%, and the residual alcohol of 0.3 v/v % was about 24 hours.

Thereafter, continuous fermentation was continuously performed by adding an aqueous solution adjusted to the extract content of 30.0 w/v %, the alcohol content of 3.0 v/v %, and the acetic acid content of 5.0 w/v % while controlling the alcohol content in the fermentation solution to 0.3 to 0.5 v/v % so as not to decrease the alcohol content in the fermentation solution to 0 v/v %. The resultant vinegar was found to have more undesirable flavor for vinegar as the fermentation time became longer.

Then, the fermentation solutions were collected at the times of 24 hours, 36 hours, 48 hours, 60 hours, 72 hours, and 84 hours, and the resultant vinegars were provided to the organoleptic test by 20 organoleptic test examiners using the vinegar collected at the time of 24 hours as a control to evaluate the flavors of the vinegars. The evaluation was performed on the five grade criteria of 1: bad, 2: slightly bad, 3: comparable, 4: slightly good, and 5: good, and the mean value of the results of the respective examiners was defined as the evaluation value. Table 2 shows the relationship between the fermentation time and flavors in the cases of different fermentation time.

TABLE 2

| Fermentation time (hour) | Flavor evaluation |
|---|---|
| 24 | — |
| 36 | 3.2 |
| 48 | 2.9 |
| 60 | 3.0 |
| 72 | 2.8 |
| 84 | 1.9 |

The results in Table 2 revealed that the evaluation of the vinegar flavor was reduced due to the extended fermentation time. That is, it was revealed that the fermentation time in the case of the extract content of 6.0 w/v % or more is preferably 72 hours or less.

### Example 3

### (1) Preparation of Inoculum Solution

An acetic acid bacterium to be added into a fermentation tank was precultured.

Acetobacter aceti IFO 3281 strain was cultivated with shaking under the conditions of 30° C. and 200 rpm for 48 hours in sterilized 804 medium (10 g of polypeptone, 10 g of yeast extract, 10 g/liter of glucose) supplemented with an alcohol (ethanol) so as to achieve 3 v/v %, to thereby obtain a preculture solution.

1,000 ml of the resultant preculture solution was added into a fermentation tank for submerged culture (10 L volume: manufactured by Mitsuwa Scientific Corp.) having 2,000 ml of a raw material solution including nutritional sources for the acetic acid bacterium, 3 v/v % alcohol, and 0.5 w/v % acetic acid, and submerged fermentation was performed under the conditions of 30° C., 500 rpm, and 0.2 vvm to initiate fermentation for preparation of an inoculum solution.

Fermentation was continued while feeding an addition solution having a composition of the extract content of 5.0 w/v % and the sum of acetic acid content and alcohol content of 8.0% from the beginning of fermentation.

At the time when fermentation proceeded until the final extract content, acetic acid content, and alcohol content reached 5.0 w/v %, 5.0 w/v %, and about 2.3 v/v %, respectively, the resultant fermentation solution was provided to the following test as an inoculum solution.

### (2) Fermentation of Apple Vinegar

To 3.0 L of the inoculum solution prepared in (1) above was added 7.0 L of a diluted solution of an apple juice with alcohol content of 5.0 v/v %, acetic acid content of 3.0 w/v %, and extract content of 77.3 w/v % so as to reach the final extract content of 55.0 w/v %, whereby performing the fermentation.

7 L of the inoculum solution was added over 25 hours and 45 minutes so as to adjust the raising rate of the extract content in the fermentation solution to 3.0 w/v % per hour. The fermentation was performed at the fermentation temperature of 30.0° C. until the acidity and residual alcohol reached 7.0% and 0.3 v/v %, respectively. After the beginning of the fermentation, the induction period did not appear, and the fermentation was completed after 37 hours. The resultant vinegar kept the original flavor of raw materials and had good flavor and sweet taste, so that it was found to be sufficiently suitable as a beverage.

### INDUSTRIAL APPLICABILITY

According to the present invention, vinegar that keeps the original flavor of raw materials and has favorable flavor for vinegar can be manufactured effectively in a short period of time without limiting the amino-acid level and the ratio of nonfermentable sugar in mash under the circumstance of high extract content.

1. A method of manufacturing vinegar by submerged fermentation, characterized by including: performing acetate fermentation using a fermentation solution which has an extract content of 0.1 w/v % or more and less than 6.0 w/v % and continues the acetate fermentation at a generation rate of acetic acid of 0.5 g/L·hr or more; raising the extract content to reach 6.0 w/v % or more and 55.0 w/v % or less at the time of completion of fermentation; and suppressing an induction period so that the induction period does not appear or is 10 hours or less, whereby obtaining vinegar with an extract content of 6.0 w/v % or more and 55.0 w/v % or less.

2. A method of manufacturing vinegar according to claim 1, characterized in that a rate of the raising of the extract content in the fermentation solution is 0.1 w/v % or more and 10.0 w/v % or less per hour in the acetate fermentation step.

3. A method of manufacturing vinegar according to claim 1, characterized in that a fermentation time in a fermentation solution with the extract content of 6.0 w/v % or more and 55.0 w/v % or less is adjusted to 72 hours or less in an acetate fermentation step.

4. Vinegar, which is manufactured by the method of manufacturing vinegar according to claim 1.

5. A method of manufacturing vinegar according to claim 2, characterized in that a fermentation time in a fermentation solution with the extract content of 6.0 w/v % or more and 55.0 w/v % or less is adjusted to 72 hours or less in an acetate fermentation step.

6. Vinegar, which is manufactured by the method of manufacturing vinegar according to claim 5.

7. Vinegar, which is manufactured by the method of manufacturing vinegar according to claim 3.

8. Vinegar, which is manufactured by the method of manufacturing vinegar according to claim 2.
